(19) United States
(12) Patent Application Publication
(10) Pub. No.: US 2007/0214917 A1
(43) Pub. Date: Sep. 20, 2007

(54) Arrangement for Securing a Handlebar to a Portable Tool

(75) Inventor: Fredrik Ejdehag, Jonkoping (SE)

Correspondence Address: PEARNE & GORDON LLP, 1801 EAST 9TH STREET, SUITE 1200, CLEVELAND, OH, 44114-3108, US

(73) Assignee: HUSQVARNA AKTIEBOLAG, Huskvarna (SE)

(21) Appl. No.: 11/570,056

(22) PCT Filed: Jun. 29, 2005
(86) PCT No.: PCT/SE05/01045

§ 371 Date: Feb. 12, 2007

(30) Foreign Application Priority Data
Jul. 1, 2004 (SE) 0401706-7

(51) Int. Cl. B25G 3/12

(52) U.S. Cl. 81/177.5

(57) ABSTRACT

The claimed invention relates to an arrangement for securing a handle bar (14) to a portable tool (10). The tool (10) comprises a power source (11) placed in one end of a tube (12) and a working tool placed in the other end of the tube (12). The handle bar (14) is secured to the tube (12) by a holding device (15) placed between the tube (12) and the handle bar (15). A sleeve (16) is placed around the tube (12) and fixed to the tube (12). The inside (25) of the sleeve (16) is shaped to match the cross section of the tube (12) and the outside (18) has a non-circular shape. The sleeve (16) is at least partially surrounded by a layer (19) of an elastic material and the holding device (15) is provided with a cavity (21) with a similar shape as the outside (18) of the sleeve (16) clamped around the sleeve (16) and the layer (19) of elastic material.

The claimed invention relates to an arrangement for securing a handle bar to a portable tool. The tool comprises an engine placed in one end of a tube and a working tool in the other end of the tube. The handle bar is secured to the tube by a holding device placed between the tube and the handle bar.

Clearing saws, trimmers, brush cutters and hedge trimmers are frequently used in order to facilitate work in forests and gardens. These tools are available in several different sizes and shapes, each of them optimized for the work that the tool is supposed to be used for and to meet the requirements from the operator. Clearing saws, trimmers, brush cutters and hedge trimmers comprises an engine and there to related components placed in one end of a tube. The drive shaft extends inside the tube from the engine to the other end of the tube where it is connected to the working tool. The length of the tube and the working tool, for example a trimmer head for a cutting filament, a saw blade, a guide bar and saw chain or a device for a hedge trimmer, are selected for the specific use of the product.

In order to improve the working conditions for the operator are these tools carried by a harness placed around the shoulders of the operator. The tool is attached to a strap extending from the harness so that the strap and the harness support the weight of the tool. The tools are also provided with a handle bar secured to the tool somewhere along the tube by a holding device. One end of the holding device is clamped to the tube and the handle bar is secured in the other end. The handle bar is used by the operator for maneuvering of the working tool during use of the tool.

The tool comprises several components that are moving when the tool is running. These components generate vibrations in the tube that are transferred to the handle bar. These vibrations are consequently also transferred to the hands of the operator via the handle bar, which is very uncomfortable for the operator.

A handle bar arrangement that improves the working conditions for the operator is therefore requested.

This problem is solved by the invention defined in the independent claim.

The claimed arrangement for securing a handle bar to a portable tool reduces the amount of vibrations transferred from the tool to the handle bar. The problem is solved by providing the tube with a sleeve fixed to the tube. The inside of the sleeve is shaped to match the cross section of the tube and the outside has a non-circular shape. The outside of the sleeve is at least partially surrounded by a layer of an elastic material. One end of the holding device for the handle bar is provided with a cavity having a similar non-circular shape as the outside of the sleeve. The cavity is clamped around the sleeve and the layer of elastic material and the handle bar secured to the opposite end of the handle bar.

The layer of elastic material reduces the vibration transferred from the tool to the handle bar and the non-circular shaped outside of the sleeve and cavity keeps the holding device in the intended position even though there is an elastic material between the sleeve and the holding device.

One preferred embodiment of the invention comprises an elastic layer that surrounds the entire sleeve. The thickness of the layer is between 2 to 15 mm. An elastic layer with bigger thickness is more efficient in reducing the amount of vibrations transferred to the handle. A thick elastic layer however makes it more complicated to clamp the holding device around the sleeve and the elastic layer in a reliably manner. The non-circular shape of the outside of the sleeve, and consequently also the elastic layer, makes it possible to fasten the holding device since the non-circular shape of the sleeve, the elastic layer and the section of the holding device that surrounds the sleeve and elastic layer will prevent movements between the sleeve and the holding device. The claimed arrangement therefore reduces the amount of vibrations transferred to the handle bar and offers reliably fastening of the handle bar to the tube.

The tube is normally circular but other shapes may be used, A non-circular shape of the tube and the inside of the sleeve is a more complicated solution but it is an efficient solution that avoids movements between the tube and the sleeve.

The outside of the sleeve and the corresponding section of the holding device are preferably oval shaped. The oval shaped sleeve and cavity in the holding device it easy to manufacture. The oval shape also makes it possible to mount the arrangement on the tube in an easy and efficient way.

One embodiment of the claimed invention is illustrated in the drawings.

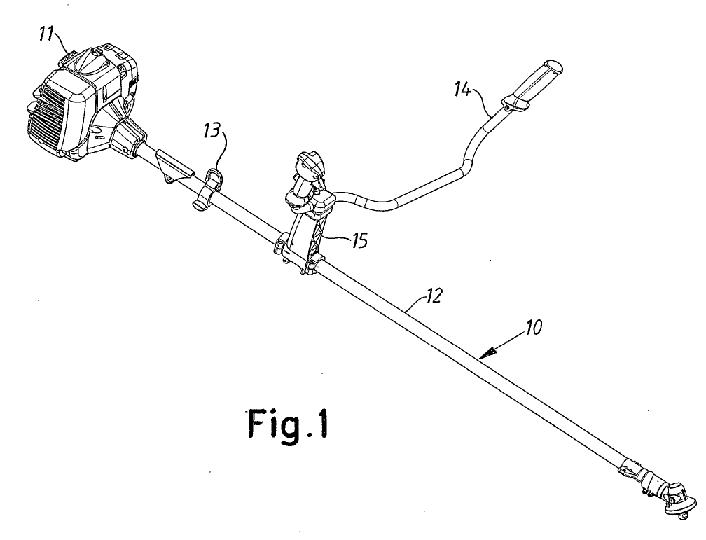

FIG. 1. Illustrates a clearing saw provided with the claimed arrangement for securing the handle bar to the tube.

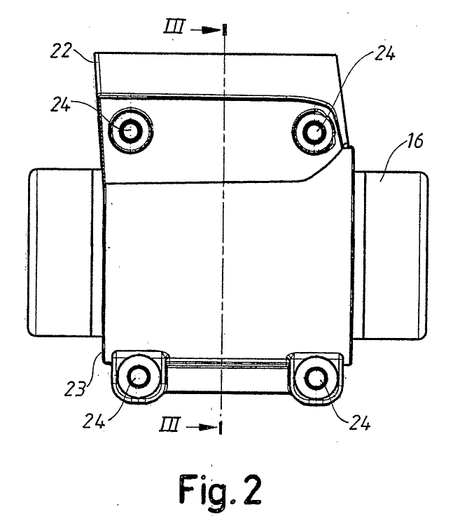

FIG. 2. Illustrates a side view of the claimed arrangement.

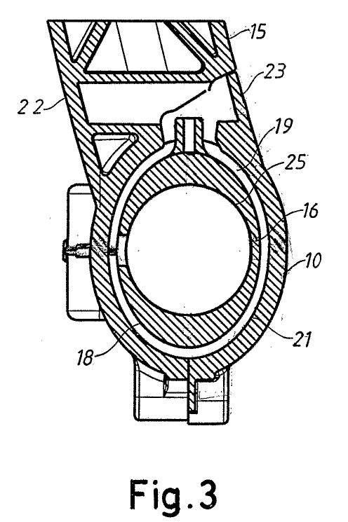

FIG. 3. Illustrates a cross section through line A-A in FIG. 2.

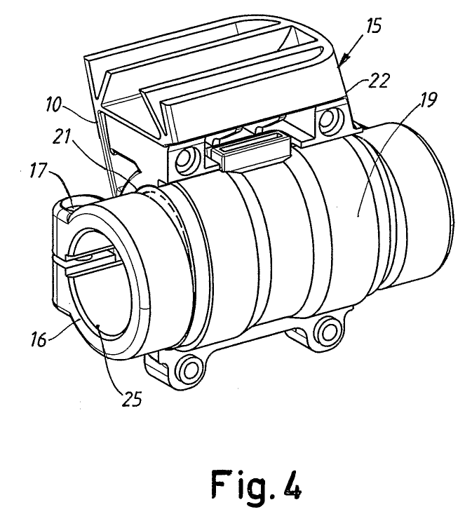

FIG. 4. Illustrates a perspective view of the claimed arrangement.

In FIG. 1 is a clearing saw with the claimed arrangement for securing a handle bar to a tool 10 illustrated. The tool comprises a power source 11, normally a combustion engine, and related components, like for example fuel tank, muffler and a starting device placed in one end of a tube 12. The tube extends in longitudinal direction of the tool. The length of the tube depends on which type of work the tool is designed for. In the opposite end as the engine is a not illustrated working tool placed. The working tool is however selected for the specific work that the tool will be used for. Other types of working tools are for example a hedge trimmer, a guide bar and a saw chain or a filament cutter. A handle bar 14 is attached to the tube 12 somewhere along the tube 12 in order to make it possible for the operator to maneuver the tool 10. The handle bar 14 is secured to the tube 12 by a holding device 15.

Tools provided with a handle bar 14 are supported by a harness or strap extending around the shoulders of the operator. The harness or strap is attached to a loop 13 secured to the tool.

The claimed arrangement for securing handle bar 14 to the tube 12 is illustrated in FIGS. 2, 3 and 4. The arrangement comprises a sleeve 16 that is fixed around the tube 14. The tube 14 has a circular cross section and the inside 25 of the sleeve 16 has a similar shape as the tube 14. The sleeve 16 is clamped to the tube 14 by a two screws 17 placed in the ends of the sleeve 16. The outside 18 of the sleeve 16 have a non-circular shape. In the illustrated embodiment is the outside 18 of the sleeve 16 oval but all other non-circular shapes could be used. A layer 19 covering substantially the entire circumference of the oval section of the sleeve 16 surrounds the sleeve 16. The layer 19 has a substantially constant thickness in radial direction around the sleeve 16 and is made of an elastic material. The elastic material will reduce the amount of vibrations transferred from the tool 10 to the handle bar 14. The thickness of the elastic layer is between 2 and 15 millimeters but to ensure a satisfying reduction of vibrations in the handle bar 14 should the elastic layer 19 be at least 3 millimeter and made of rubber or a material with similar features.

The elastic layer 19 is surrounded by a cavity 21 in a first end 20 of the holding device 15. The cavity 21 has the same non-circular shape as the outside 18 of the sleeve 16. The non-circular shape of the outside 18 of the sleeve 16 and the cavity 21 in the holding device 15 keeps the holding device 15 in the predetermined position in relation to the sleeve 16 even though the sleeve 16 is surrounded by the elastic layer 19. This feature is essential for the claimed invention.

The thickness of the elastic layer 19, the outside 18 shape of the sleeve 16 and the cavity may vary in axial direction along the tube 12 to avoid movements in axial direction between the sleeve 16, the elastic layer 19 and the holding device 15. A changed thickness of the elastic layer 19, the outside 18 shape of the sleeve 16 and the cavity must however be accomplished by a similar change in the close contact layer or surface.

The first end 20 of the holding device 15 comprises a first section 22 with one part of the cavity 21 and a second section 23 with the remaining part of the cavity 21. The two sections 22 and 23 are necessary to make it possible to mount and secure the holding device 15 around the sleeve 16 and the elastic layer 19. The second section 23 is screwed to the first section 22 integrated in the holding device 15 by four screws 24. The cavity could also be divided into more than two sections 22 and 23 if that for some reason is favorable. The number of screws could also vary.

The second end of the holding device 15, illustrated in FIG. 1, fastens the handle bar to the tool.

1. Arrangement for securing a handle bar (14) to a portable tool (10) comprising a power source (11) placed in one end of a tube (12) and a working tool placed in the other end of the tube (12), said handle bar (14) is secured to the tube (12) by a holding device (15) placed between the tube (12) and the handle bar (14), characterized in that a sleeve (16) is fixed around the tube (12), the inside (25) of said sleeve (16) is shaped to match the cross section of the tube (12) and the outside (18) has a non-circular shape, said sleeve (16) is at least partially surrounded by a layer (19) of an elastic material, said holding device (15) is provided with a cavity (21) with a similar shape as the outside (18) of the sleeve (16) and clamped around the sleeve (16) and layer (19) of elastic material.

2. Arrangement according to claim 1, characterized in that the tube (12) and then inside (25) of the sleeve (16) have a circular cross section.

3. Arrangement according to claim 1 or 2, characterized in that the outside (18) of the sleeve (16) and the cavity (21) have an oval shape.

4. Arrangement according to claim 1, characterized in that the layer (19) of elastic material is extending around substantially the entire sleeve (16).

5. Arrangement according to claim 1, characterized in that the layer (19) of elastic material is made of rubber or a material with similar features.

6. Arrangement according to claim 1, characterized in that the thickness of the layer (19) of elastic material is 2 to 15 millimeter.

7. Arrangement according to claim 6, characterized in that the thickness of layer (19) of elastic material is 3 to 7 millimeters.

8. Arrangement according to claim 1, characterized in that the end (20) of the holding device (15) where the cavity (21) is located comprises at least to sections (22, 23) dividing the cavity (21) into at least two parts to make it possible to clamp the holding device (15) around the sleeve (16).
